(19) United States
(12) Patent Application Publication
(10) Pub. No.: US 2017/0359319 A1
(43) Pub. Date: Dec. 14, 2017

(54) ADDING A DEVICE TO A PROTECTED NETWORK WITHOUT DATA ENTRY ON THE DEVICE

(71) Applicant: SiliconDust USA Inc., Pleasanton, CA (US)

(72) Inventor: Nicholas John KELSEY, Milpitas, CA (US)

(21) Appl. No.: 15/526,992

(22) PCT Filed: Nov. 16, 2015
(86) PCT No.: PCT/US15/60928

§ 371 Date: May 15, 2017

Related U.S. Application Data
(60) Provisional application No. 62/123,347, filed on Nov. 15, 2014.

(51) Int. Cl. H04L 29/06; H04W 12/02; H04W 12/04

(52) U.S. Cl. CPC H04L 63/0457; H04W 12/04; H04W 12/02; H04L 63/0492

(57) ABSTRACT

An apparatus comprising a processor configured to cause the apparatus to perform operations including: detecting a protected wireless network; observing a set of encrypted wireless data packets being transmitted by one or more devices participating in the protected wireless network, wherein configuration information for participating in the protected wireless network has been encoded according to a predefined protocol in sizes or times of transmission of the set of encrypted wireless data packets; determining the configuration information based on sizes or times of receipt of a portion of each of the set of encrypted wireless data packets; and participating in the protected wireless network using the determined configuration information.

### CROSS REFERENCE TO RELATED APPLICATION

This application claims the benefit of priority to a provisional patent application filed at the United States Patent and Trademark Office having Ser. No. 62/123,347, filed on Nov. 15, 2014, the entire content of which is incorporated herein by reference.

### TECHNICAL FIELD

The disclosure relates generally to computer networking and specifically to adding a device to a protected network without data entry on the device by sending encoded configuration information in certain characteristics of encrypted data transmitted through the protected network.

### BACKGROUND

Most people have a wireless network such as 802.11 WiFi in their home and/or workplace. Best practice suggests to enable encryption with password protection such as Wi-Fi Protected Access Pre-Shared Key (WPA-PSK) to prevent unauthorized access to the wireless network, thereby protecting the wireless network. In the context of this disclosure, the phrase “protected wireless network” refers to a wireless data communication network in which transmissions by devices configured to participate in the protected wireless network are encrypted, and one or more credentials (configuration information), such as but not limited to a password, are required for a device to participate in the protected wireless network so as to decrypt transmissions or encrypt transmissions for successful decryption by other devices participating in the protected wireless network. Such credentials for a protected wireless network may also be referred to a configuration information for the protected wireless network. A wireless access point (AP, wireless home router, wireless home gateway, etc.) is configured with a network name, such as a SSID (service set ID), and a password for the protected wireless network. Subsequent to configuration, when a new computing device (such as, for example, a computer or a smartphone) is introduced, the wireless network name and password can be entered into the new computing device. If the passwords match, the new computing device can join and successfully participate in and make use of the protected wireless network.

Specifying configuration information for participating in a protected wireless network, such as a network name and password, works well for devices that support typing or entering text such as a laptop, tablet, phone, etc. However, specifying such configuration information may be a problem on devices that do not support typing or otherwise entering text such as a password, do not support displaying a user interface (UI) without network access, or have limited ability to do one, the other, or both. Examples of such devices include, but are not limited to, stereo/home theater equipment, HDMI dongle form factor devices, televisions, set-top boxes, game consoles, printers, video streaming devices, computer input devices (joysticks, keyboards, mice, etc.), power monitor devices, home appliances, medical devices, home security equipment, cameras, etc. This is not an exhaustive list and the term “device” in this context can be used in a general sense to refer to something that is capable of communicating via a wireless network. Some devices that support entering text and displaying a user interface today may be improved or made more cost effective by removing the need to specify configuration information via a UI for a protected wireless network. Also, some devices support entering text via up/down/left/right style controls which can be slow and/or cumbersome to use.

One set of conventional techniques for adding a new device to a protected wireless network without data entry on the device is described in the Wi-Fi Protected Setup (WPS) standard, by the Wi-Fi Alliance, which is incorporated herein by reference in its entirety, which may require special support on both a wireless access point and a device to be added. However, some access points may not support Wi-Fi Protected Setup. Various methods for Wi-Fi Protected Setup may include having a personal identification number read from the device (displayed or printed on a label); having a push button on both the access point and the device; using a Near Field Communication (NFC) which is optional even for access points that claim to support Wi-Fi Protected Setup; or using a USB flash drive. However, the above methods can lead to further issues; for example, due to possible security issues, recommended practice is to disable methods such as displaying or printing labels on a device. Therefore support for such methods has been deprecated.

Another conventional technique for adding a new device to a protected wireless network involves putting the new device into a setup mode where it temporally operates as a wireless access point to provide a temporary network. A user can then use a laptop, tablet, or smartphone that can provide a UI and receive user input to join the temporary network so it can access the device and configure it with configuration information for the protected wireless network that the device is intended to join. This method may have the advantage of working with an existing access point (that does not support, for example, WPS) as it does not rely on special or optional features being implemented by the existing access point. The down side, however, is that this technique may involve a complex series of steps for the user to perform. For example, the user may have to know how to put the new device into the setup mode to temporarily operate as a wireless access point, how to change wireless network settings on their laptop/tablet/smartphone to join the temporary wireless access point, install an app or know how to access the new device, recognize when the new device fails to join the network and how to recover from such failures, remember to change settings on the laptop/tablet/smartphone back to using the original protected wireless network, etc.

### SUMMARY

In a general aspect, an apparatus is provided. The apparatus includes a processor configured to cause the apparatus to perform operations including: detecting a protected wireless network; observing a set of encrypted wireless data packets being transmitted by one or more devices participating in the protected wireless network, wherein configuration information for participating in the protected wireless network has been encoded according to a predefined protocol in sizes or times of transmission of the set of encrypted wireless data packets; determining the configuration information based on sizes or times of receipt of a portion of each of the set of encrypted wireless data packets; and participating in the protected wireless network using the determined configuration information.

The operations also include: generating a first bitstream based on sizes or times of receipt of portions of each of the set of encrypted wireless data packets; generating a second bitstream by applying Forward Error Correction (FEC) processing to the first bitstream; and determining the configuration information based on the second bitstream.

The operations further include: generating a first bitstream based on sizes or times of receipt of portions of each of the set of encrypted wireless data packets; generating a second bitstream by decrypting the first bitstream using a decryption key; and determining the configuration information based on the second bitstream.

The operations further include: obtaining the decryption key based on data stored in the apparatus; and decrypting the second bitstream using the decryption key as a private key for a public-key cryptographic algorithm

The apparatus may include a housing bearing an indicia corresponding to a public key effective for encoding data for decryption using the decryption key. The operations may further include providing an indication that the apparatus successfully determined the configuration information to a device participating in the protected wireless network or to a server outside of the protected wireless network.

In another aspect a method is provided. The method includes: receiving a notification from the second device indicating that the second device was unable to determine the configuration key based on data packets received by the second device in response to the transmitting of the set of data packets; determining, in response to receiving the notification, second sizes or times of transmission for a second set of data packets, wherein the second sizes or times of transmission encode the configuration information according to a second predefined protocol, wherein the second protocol is different from the first protocol; and generating and transmitting, to the second device via the one or more established network connections, the second set of data packets according to the determined second sizes or times of transmission.

The method further includes generating a first bitstream based on the configuration information; generating a second bitstream by Forward Error Correction (FEC) processing of the first bitstream; and determining the first sizes or times of transmission based on the second bitstream.

The method also includes obtaining an encryption key for the first device; generating a first bitstream based on the configuration information; generating a second bitstream by encrypting the first bitstream using the encryption key; and determining the first sizes or times of transmission based on the second bitstream. The one or more network connections may include one or more TCP/IP based connections. The one or more network connections may include HTTP connections initiated by the second device.

In yet another aspect of the disclosure, a method for providing configuration information for a protected wireless network to a first device to allow the first device to participate in the protected wireless network, is provided. The method includes requesting, via the protected wireless network, a webpage from a server; receiving the webpage, wherein the webpage includes first instructions which, when executed by a second device participating in the protected wireless network, cause the second device to transmit a first set of encrypted data packets via the protected wireless network; obtaining the configuration information for the protected wireless network; executing the first instructions to transmit, via the protected wireless network, the first set of encrypted data packets, wherein the first set of encrypted data packets have first sizes or times of transmission that encode the configuration information according to a first predefined protocol.

The method may further include: determining that the first device did not begin participating in the protected wireless network; receiving second instructions which, when executed by the second device, cause the second device to transmit a second set of encrypted data packets via the protected wireless network; executing the second instructions to transmit, via the protected wireless network, the second set of encrypted data packets, wherein the second set of encrypted data packets have second sizes or times of transmission that encode the configuration information according to a second predefined protocol, wherein the second protocol is different from the first protocol. The first set of encrypted data packets may encode the configuration information based on a Forward Error Correction (FEC) processing technique.

The method further includes: obtaining the configuration information via a user interface provided by the second device; and executing the first instructions to determine the first sizes or times of transmission based on the obtained configuration information. The second device may be an access point associated with the protected wireless network.

In yet another aspect of the disclosure, a method for providing configuration information for a protected wireless network to a first device to allow the first device to participate in the protected wireless network is provided. The method includes: obtaining the configuration information for the protected wireless network; determining sizes or times of transmission for a set of encrypted data packets, wherein the sizes or times of transmission encode the configuration information according to a predefined protocol; and transmitting the set of encrypted data packets via the protected wireless network. The set of encrypted data packets may encode the configuration information based on a Forward Error Correction (FEC) processing technique. The set of encrypted data packets may include UDP packets. The set of encrypted data packets may include broadcast or multicast packets.

Other features and aspects will be apparent from the following detailed description, the drawings, and the claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an example of a protected network and devices involved in adding a device to the protected network, according to an embodiment of the disclosure.

FIG. 2 illustrates an example of adding a device to a protected wireless network by use of a webpage, according to an embodiment of the disclosure.

FIG. 3 illustrates an example of adding a device to a protected wireless network via a computing device connected to the protected wireless network, according to an embodiment of the disclosure.

FIG. 4 illustrates an example of adding a device to a protected wireless network by use of an application, according to an embodiment of the disclosure.

FIGS. 5A-5C illustrate examples of packet encoding, according to various embodiments.

FIG. 6 is a block diagram that illustrates a computer system upon which aspects of this disclosure may be implemented.

### DETAILED DESCRIPTION

The following detailed descriptions are presented to enable any person skilled in the art to make and use the disclosed subject matter. For purposes of explanation, specific nomenclature is set forth to provide a thorough understanding. However, it will be apparent to one skilled in the art that these specific details are not required to practice the disclosed subject matter. Descriptions of specific applications are provided only as representative examples.

Various modifications to the preferred embodiments will be readily apparent to one skilled in the art, and the general principles defined herein may be applied to other embodiments and applications without departing from the scope of this disclosure. The sequences of operations described herein are merely examples, and the sequences of operations are not limited to those set forth herein, but may be changed as will be apparent to one of ordinary skill in the art, with the exception of operations necessarily occurring in a certain order. Also, description of functions and constructions that are well known to one of ordinary skill in the art may be omitted for increased clarity and conciseness. This disclosure is not intended to be limited to the embodiments shown, but is to be accorded the widest possible scope consistent with the principles and features disclosed herein.

This disclosure describes a system and method for providing a device with configuration information for a protected wireless network to join and participate in the protected wireless network by using another device such as, but not limited to, a computer, a laptop, a tablet, a smartphone, or a wireless access point that is already participating in the protected wireless network. The configuration information can be communicated to the device through the same protected wireless network that the device is not yet configured for, despite the device not yet having configuration information needed to decrypt data being transmitted by devices participating in the protected wireless network. It is noted that the features of this disclosure can be used with various communication protocols such as TCP/IP, in general, and various application layers such as, for example, Hypertext Transfer Protocol (HTTP), secure communication protocol (HTTPS), voice over Internet protocol (VOIP), etc.

The device can receive the wireless network traffic from a protected wireless network that is on the same channel and within range. The device may not, however, be able to decrypt the contents of high level network traffic or send meaningful high level network traffic until it has been provided with configuration information for the protected wireless network, such as, but not limited to, a network name and password.

This disclosure describes using techniques to convey configuration information to the device by transmitting wireless network packets that are neither addressed to nor decryptable by the device. The configuration information can be conveyed through, for example, use of packet size and/or packet position encoding, with scrambling and forward error correction to increase security and robustness associated with conveying the configuration information.

The various approaches discussed in this disclosure has the advantage of being compatible with a conventional access point as the access point does not need to be involved with the described protocols beyond the normal wireless packet handling duties of the access point.

Furthermore, encoding of the configuration information for a protected wireless network can be implemented with custom sized and/or custom timed (positioned) packets issued by, for example, a web server on the Internet outside of the protected wireless network, thus no special client-side software may be required beyond a web browser (which also may not be required in some implementations). Once the device has been determined the configuration information for a protected wireless network, it can be suitably configured to join and participate in the protected wireless network following normal protocols.

It is noted that although this disclosure makes references to adding a new device to a protected wireless network, the techniques described herein may also be applied for adding a new device to a protected wired network that requires a new device to possess certain configuration information, such as, but not limited to, a password, to participate in the protected wired network. Additionally, the techniques described herein may also be applied to or used in conjunction with optical-based communication, ultrasonic or other audio-based signaling or networking, and mesh-based networks.

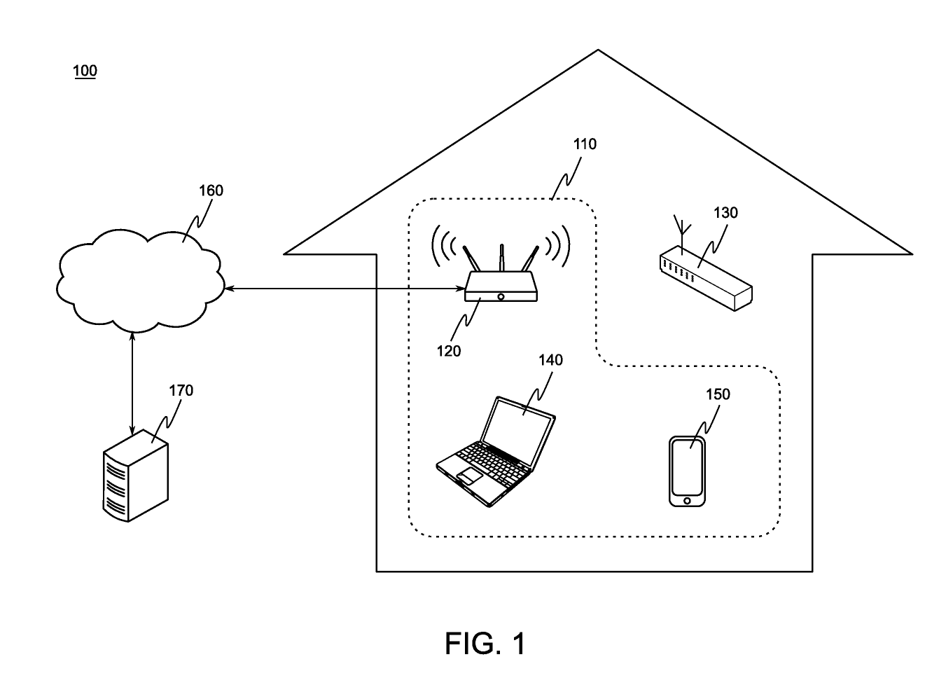

FIG. 1 illustrates an example of a protected wireless network 110 and devices involved in adding a device 130 to the protected wireless network 110, according to an embodiment of the disclosure. As described herein, a device 130 is being added to an existing protected wireless network 110 using a computer, laptop, tablet, smartphone, etc., such as, but not limited to, a laptop 140 and a smartphone 150 illustrated in FIG. 1. Configuration information for device 130 can be communicated to the device 130 through the same protected wireless network 110 that the device 130 is not yet configured for. The device 130 can be a new device within range of the wireless network 110 as illustrated in FIG. 1. The wireless network 110 can be connected to a server 170 via a network 160 (such as, but not limited to, the Internet). Although FIG. 1 illustrates an example in which server 170 is outside of protected wireless network 110, in some examples server 170 may participate in protected wireless network 110.

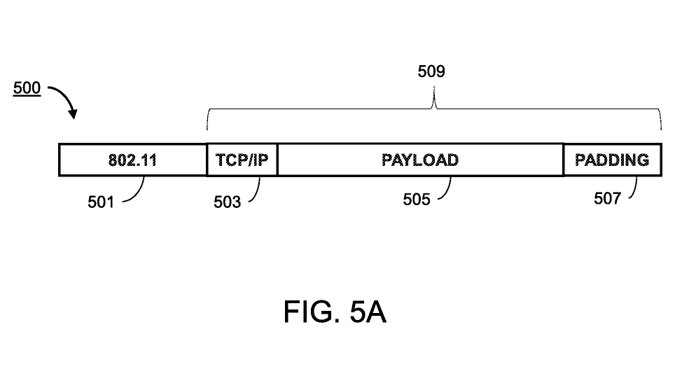

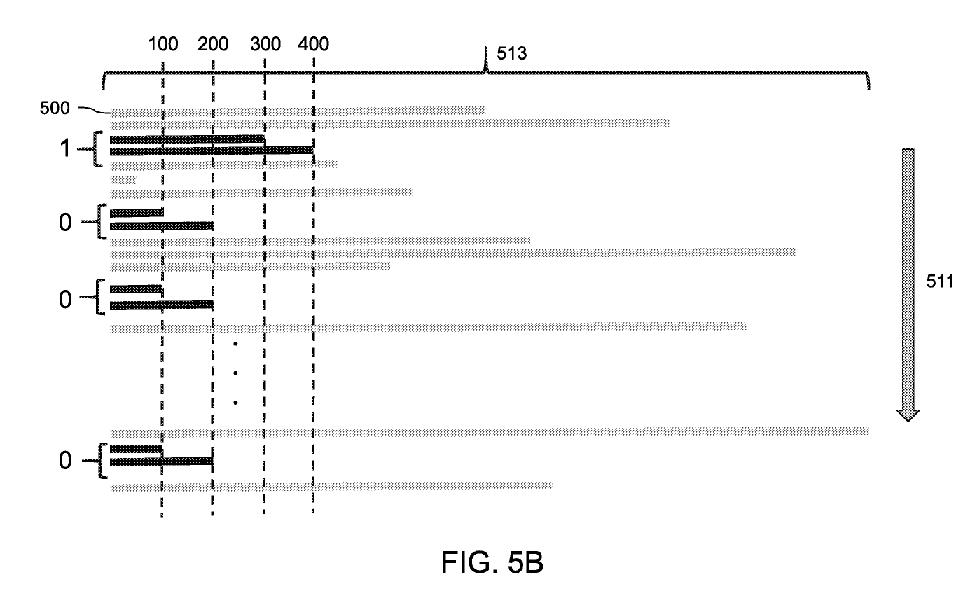

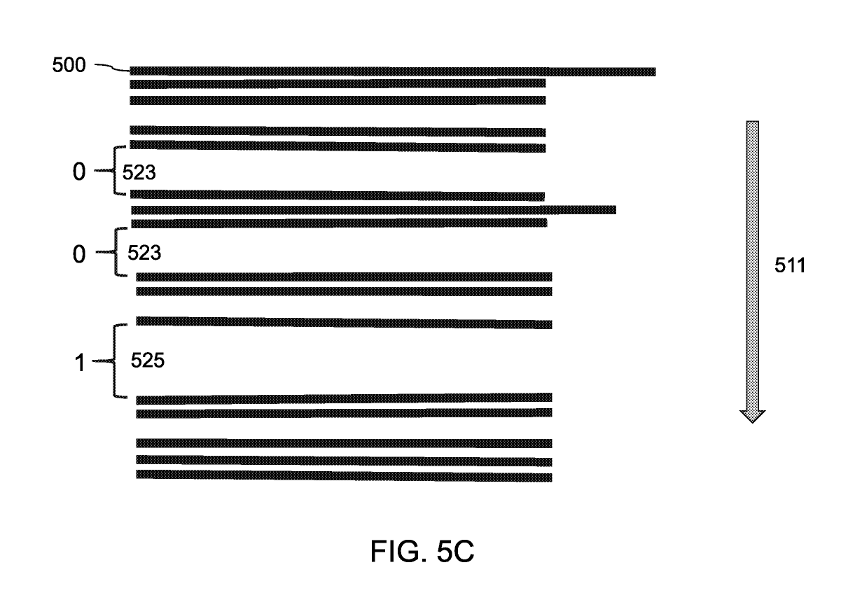

The configuration information can be conveyed from server 170, laptop 140 or phone 150 through the use of packet size and/or packet position encodings (for example, timings of transmission or receipt of data packets), such that the device 130 can receive the configuration information from encrypted packets it observes without being able to decrypt the observed packets. Some examples of the conveyance of configuration information through packet size or packet timing is further discussed below with respect to FIGS. 5A-5C.

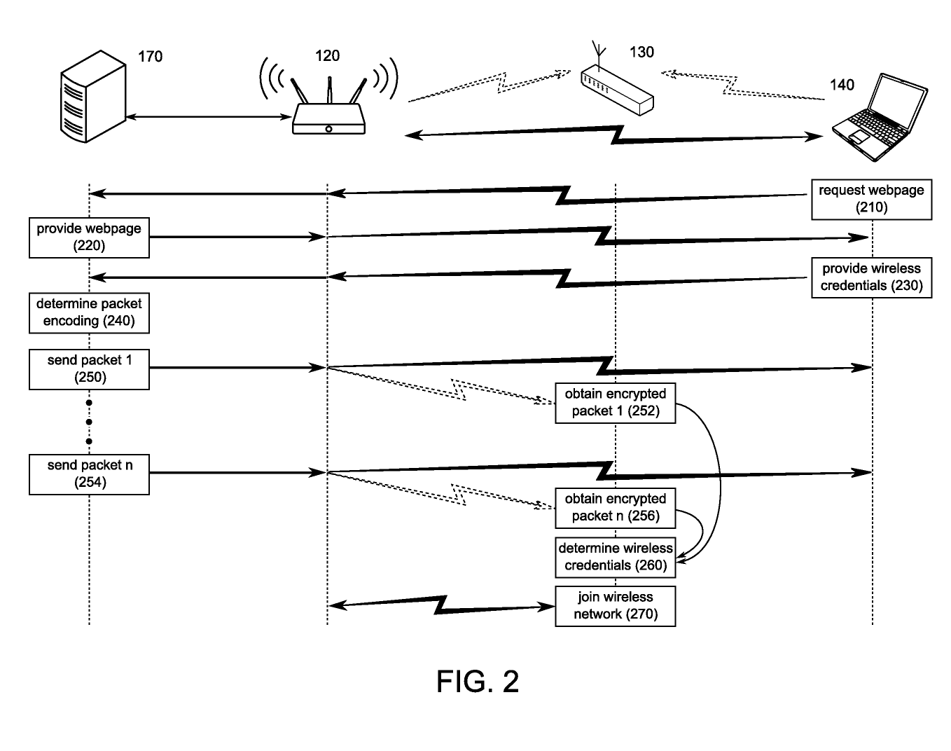

FIG. 2 illustrates an example of adding a device 130 to a protected wireless network 110 by use of a webpage provided by a server 170 in response to a network connection initiated by laptop 140 and an HTTP request initiated by laptop 140. In some embodiments the device 130 can operate in a promiscuous mode listening to wireless network traffic regardless of the destination address or wireless data packets. This approach can be used since the device 130 is not yet known to the access point 120 as a participant of protected wireless network 110 and so the access point 120 may not send packets addressed to the device 130. The promiscuous mode approach means a packet sequence can be generated by an internet web server 170 communicating with a user's web browser (for example on laptop 140) that communicates via protected wireless network 110, and encrypted packets wirelessly transmitted by access point 120 to laptop 140 may be overheard and obtained by the device 130. This has the advantage of not requiring any client-side software on laptop 140 beyond a web browser.

As illustrated in FIG. 2, at step 210 the user may activate a web browser app or application on laptop 140 and the web browser initiates one or more network connections with server 170 via which laptop 140 requests a webpage from server 170 via the Internet. In some implementations, the webpage may also be used for the purpose of registering the device 130 as a newly purchased or activated product. It is noted that although FIG. 2 illustrates an embodiment in which server 170 functions as a web server, server 170 may interact with laptop 140 and access point 120 via other forms of network connections initiated by laptop 140 and provide configuration information to laptop 140 via other protocols than HTTP. For example, laptop 140 may initiate and establish a simple TCP socket connection with server 120 via IP masquerading or other network address translation (NAT) techniques, such that data transmitted from server 170 to laptop 140 via the socket connection results in encrypted wireless data packets being transmitted from access point 120 to laptop 140. Also, although FIG. 2 illustrates laptop 140 as communicating with server 170, likewise smartphone 150 can similarly communicate with server 170.

At step 220 the server 170 provides the webpage to laptop 140. At step 230 the user of laptop 140 can provide configuration information associated with the protected wireless network 110 which is required for configuring device 130 to participate in the protected wireless network 110. For example, the webpage provided at 220 may include a text entry field to allow the configuration information to be submitted via a web browser program. In some examples, the web browser may encrypt the configuration information before providing it to server 170, for example, the configuration information may be encrypted using a public key for a public-key encryption algorithm, and device 130 may possess the corresponding private key for decryption, thereby ensuring that server 170 is not provided with an unencrypted version of sensitive configuration information. The device 130 may obtain the decryption key based on data stored in a local memory of device 130.

The server 170 may verify configuration information included in the configuration information and upon verification the server 170 can determine (at step 240) how to encode the configuration information by determining sizes or times of transmission for a set of data packets that will be sent to laptop 140 and observed by device 130. As illustrated in steps 250 and 254, the server 170 can generate and transmit a set of packets 1 to n to laptop 140, based on the sizes or times of transmission determined at 240. Various techniques may be employed for sending packets 1 to n from server 170 to laptop 140. In a first example, the webpage sent at 220 or another webpage obtained by laptop 140 from server 170 may cause a web browser app or program to establish a WebSocket, across which server 170 may transmit multiple data packets with arbitrary sizes or transmission times. In a second example, the webpage sent at 220 or another webpage obtained by laptop 140 from server 170 may cause a web browser app or program to issue multiple requests for resources from server 170. For example, the HTML for the webpage might include the following image references, which each result in respective requests for resources from server 170:
http://server/packet-generate.png?sequence=1&size=600
http://server/packet-generate.png?sequence=2&size=400
http://server/packet-generate.png?sequence=3&size=700
http://server/packet-generate.png?sequence=4&size=600
   The “sequence” value may be used by server 170 to serialize multiplexed requests, and the “size” value may be used to return a PNG resource of the specified size in bytes. The webpage may cause a web browser to retrieve such resources, but not display them. The above resource requests may be issued in response to a script, such as ECMAScript, executed in response to the contents of the webpage, which may better ensure serialization or timings of resource requests. The third example is not limited to an image resource, other resources such as, but not limited to, CSS or ECMAScript may also be specified and retrieved. There are many other well-known techniques by which a webpage received by a web browser may enable or facilitate the transmission of multiple resources or packets from a server, such as server 170, to the web browser.

As wireless access point 120 receives data packets 1 to n from server 170, it transmits at least a portion of the received packets 1 to n within encrypted wireless data packets 1 to n for receipt by laptop 140. Since the device 130 is in the range of protected wireless network 110, device 130 can obtain the encrypted packets 1 to n, per steps 252 and 256, by “overhearing” the encrypted wireless transmissions.

In step 260, which may be performed incrementally as encrypted packets 1 to n are obtained, the device 130 can determine the configuration information based on sizes or times of receipt for encrypted packets 1 to n. In some implementations, a first bitstream for the configuration information may be obtained based on sizes or times or receipt of encrypted packets 1 to n. The configuration information may be determined based on the first bitstream. That determination may further involve performing a Forward Error Correction (FEC) processing on the first bitstream and/or using a decryption key to decrypt the first bitstream or a bitstream derived from the first bitstream. The device 130 may include a private key for a public-key encryption algorithm for determining the configuration information. Thus, the device 130 can determine the configuration information without decrypting the content of encrypted packets 1 to n, for example, based on packet lengths, packet positions, packets timing, etc. as is further discussed in FIGS. 5A-5C. Upon determining the configuration information for configuring device 130 to join and participate in the protected wireless network 110, per step 270 the device 130 can join the protected wireless network 110 using the determined configuration information.

The user of laptop 140 can scan a device-unique quick response (QR) code, or other indicia, printed on a housing of device 130 or included with the device 130 to bring up an internet website 220 in a web browser 210 on the computing device 140 used to scan the QR code. The QR code may include, for example as part of a uniform resource locator (URL), information that identifies device 130 or from which a public key or other encryption key may be derived for encrypting configuration information. The user can submit the protected wireless network name and/or password. The device 130 identified by the QR code can then be configured by the web server 170 sending encrypted data packets to the client 140 via wireless access point 120 (as illustrated by 250 and 254 in FIG. 2), with the intent that corresponding encrypted wireless data packets 1 to n will be transmitted and overheard by the device 130.

Although not illustrated in FIG. 2, the device 130 may provide an indication that it successfully determined the configuration information for protected wireless network 110. For example, it may transmit such an indication to server 170. As another example, device 130 may transmit such an indication to laptop 140 or provide an indication in response to a query issued by laptop 140. This indication may be used by server 170 or laptop 140 to determine if device 130 failed to determine the configuration information. For example, in some instances data from multiple packets may be combined by a router into a single packet, or a router may split a single packet into multiple packets. Also, timings of packets may not be maintained as they traverse from server 170 to laptop 140.

Packets may be received by laptop 140 in a different order than they were initially transmitted. Such packet “mangling” may result in encrypted wireless packets that fail to be decoded properly by device 130, despite redundancy or error correction provided by FEC processing. A failure of device 130 to provide an indication that it successfully determined the configuration information may cause server 170 to generate a new encoding according to a different predefined protocol (for example, using different sizes or slower or different timings), and transmit a new sequence of data packets to laptop 140 to be overheard by device 130. In some examples, laptop 140 may attempt to process encrypted packets 1 to n and provide a notification to server 170 when it detects an error associated with attempting to process encrypted packets 1 to n. Such a notification may include information that assists server 170 in determining how it might differently encode the configuration information.

In some implementations, access point 120 may be configured to provide configuration information to device 130 without assistance from server 170. For example, laptop 140 may access a webpage provided by access point 120 to initiate configuring device 130. As access point 120 already possesses the configuration information, it may then directly generate wireless data packets that encode the configuration information by sizes or times of transmission to configure device 130. Additionally, access point 120 may be configured to identify whether device 130 joins the protected wireless network after transmitting the configuration packets, and send a different set of configuration packets encoding the configuration information according to a different predetermined protocol is response to a determination that device 130 did not join the protected wireless network.

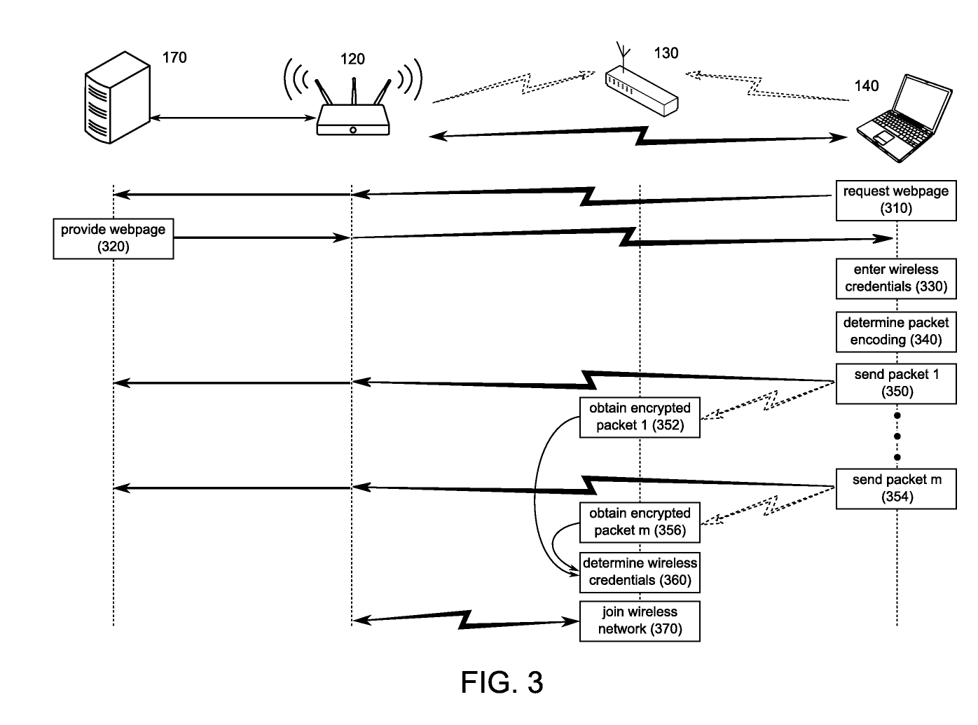

FIG. 3 illustrates an example of adding a device 130 to a protected wireless network 110 via a computing device 140 connected to the protected wireless network, in response to a network connection initiated by laptop 140 and an HTTP request initiated by laptop 140. The device 130 can listen for broadcast or select multicast traffic rather than operating in promiscuous mode, as might also be done with regards to an implementation of the example illustrated in FIG. 2. This can provide better packet filtering. In some implementations, device 130 may perform filtering based on various unencrypted fields of a wireless data packet, such as, but not limited to, a media access control (MAC) address or basic service set identity (BSSID).

As illustrated in FIG. 3, at step 310 the user may activate a web browser app or program on laptop 140 and the web browser initiates one or more network connections with server 170 via which laptop 140 requests a webpage from server 170 via the Internet. It is noted that although FIG. 3 illustrates an embodiment in which server 170 functions as a web server, server 170 may interact with laptop 140 and access point 120 via other forms of network connections initiated by laptop 140. For example, laptop 140 may initiate and establish a simple TCP socket connection with server 120 via IP masquerading or other network address translation (NAT) techniques, such that data transmitted from server 170 to laptop 140 via the socket connection results in encrypted wireless data packets being transmitted from access point 120 to laptop 140. Also, although FIG. 3 illustrates laptop 140 as communicating with server 170, likewise smartphone 150 can similarly communicate with server 170.

At step 320 the server 170 provides the webpage to laptop 140. At step 330 the user of laptop 140 can provide configuration information associated with the protected wireless network 110 which is required for configuring device 130 to participate in the protected wireless network 110. For example, the webpage provided at 320 may include a text entry field to allow the configuration information to be submitted via a web browser program. In some examples, the web browser may encrypt the configuration information; for example, the configuration information may be encrypted using a public key for a public-key encryption algorithm, and device 130 may possess the corresponding private key for decryption, thereby ensuring that another party cannot obtain an unencrypted version of sensitive configuration information for the protected wireless network.

The web browser may verify configuration information included in the configuration information and upon verification the laptop 140 can determine (at step 340) how to encode the configuration information by determining sizes or times of transmission for a set of data packets that will be sent to laptop 140 and observed by device 130. In a first example, the webpage received at 320 may include instructions for the web browser, such as, but not limited to, an ECMAScript script, which causes laptop 140 to determine the sizes or times of transmission.

In another implementation, server 170 may receive configuration information, much as discussed above with respect to FIG. 1, perform the determination of step 340 at server 170, and provide a webpage to laptop 140 with instructions, such as HTML elements included in or pulled in by the webpage which are processed and executed by a web browser, which cause laptop 140 to issue data packets with the determined sizes or times of transmission. For example, the webpage might cause a web browser to request the following resource:
http://server/packet-sink?randomdatarandomdatarandomdata
   which has 30 bytes after the “?” character in the URL, and might result in the following HTTP GET request being issued to server 170:
GET/packet-sink?randomdatarandomdatarandomdata HTTP/1.1
User-Agent: Mozilla/4.0 (compatible; MSIE5.01; Windows NT)
Host: server
Accept-Language: en-us
Accept-Encoding: gzip, deflate
Connection: Keep-Alive
   which is a packet of 217 bytes in length, or 187 bytes longer than the portion of the URL after the “?” character. Based on interactions between server 170 and laptop 140, such as the request issued at 310, server 170 can determine or estimate this additional amount of 187 bytes for HTTP request header data, and accordingly generate the webpage provided at 320 so as to result in laptop 140 generating data packets of the determined and/or desired sizes for providing the configuration information to device 130.

As illustrated in steps 350 and 354, the laptop 140 can generate and transmit the set of packets 1 to m to server 170, based on the sizes or times of transmission determined at 340. As wireless access point 120 receives data packets 1 to m from laptop 140, it transmits at least a portion of the received packets 1 to m within encrypted wireless data packets 1 to m for receipt by server 170. Since, the device 130 is in the range of protected wireless network 110, device 130 can obtain the encrypted packets 1 to m, per steps 352 and 356, by “overhearing” the encrypted wireless transmissions. In step 360, which may be performed incrementally as encrypted packets 1 to m are obtained, the device 130 can determine the configuration information based on sizes or times of receipt for encrypted packets 1 to m. In some implementations, a first bitstream for the configuration information may be obtained based on sizes or times or receipt of encrypted packets 1 to m.

The configuration information may be determined based on the first bitstream. That determination may further involve performing a Forward Error Correction (FEC) processing on the first bitstream and/or using a decryption key to decrypt the first bitstream or a bitstream derived from the first bitstream. The device 130 may include a private key for a public-key encryption algorithm for determining the configuration information. Thus, the device 130 can determine the configuration information without decrypting the content of encrypted packets 1 to m, for example, based on packet lengths, packet positions, packets timing, etc. as is further discussed in FIGS. 5A-5C. Upon determining the configuration information for configuring device 130 to join and participate in the protected wireless network 110, per step 370 the device 130 can join the protected wireless network 110 using the determined configuration information.

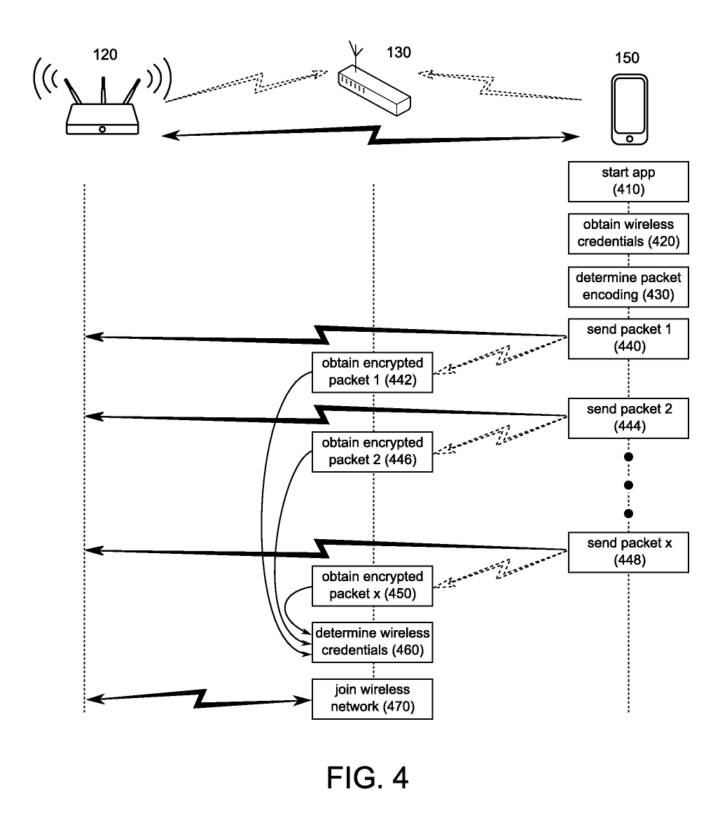

FIG. 4 illustrates an example of adding a device 130 to a protected network 110 using a software application, according to an embodiment of the disclosure. The device 130 can listen for traffic within the protected wireless network 110. The user can run a software component or application on their computing device (e.g., phone 150) capable of sending broadcast or multicast traffic. As illustrated in FIG. 3, at step 410 the user may activate a software application on phone 150. The software application may initiate a request for the user to enter wireless configuration information via phone 150. At step 420 the software application can obtain and validate the configuration information. Once the configuration information are validated, in step 430 the phone 150 can generate a set of encrypted packets encoding the configuration information for device 130. As illustrated in steps 440, 444, and 448 the phone 150 can transmit the set of packets 1 to x to access point 120. Since, the device 130 is in the range of protected wireless network 110, device 130 can obtain the encrypted packets 1 to x, per steps 442, 446, and 450, by “overhearing” the encrypted wireless transmissions.

In step 460, which may be performed incrementally as encrypted packets 1 to m are obtained, the device 130 can determine the configuration information based on sizes or times of receipt for encrypted packets 1 to m. In some implementations, a first bitstream for the configuration information may be obtained based on sizes or times or receipt of encrypted packets 1 to m. The configuration information may be determined based on the first bitstream. That determination may further involve performing a Forward Error Correction (FEC) processing on the first bitstream and/or using a decryption key to decrypt the first bitstream or a bitstream derived from the first bitstream. The device 130 may include a private key for a public-key encryption algorithm for determining the configuration information. Thus the device 130 can determine the configuration information without decrypting the content of encrypted packets 1 to x, for example, based on packet lengths, packet positions, packets timing, etc. as is further discussed in FIGS. 5A-5C. Upon determining the configuration information for configuring device 130 to join and participate in the protected wireless network 110, per step 470 the device 130 can join the protected wireless network 110 using the determined configuration information.

In some instances, the user can run a software component or application on their computing device (e.g., laptop 140) capable of sending broadcast or multicast traffic. For example, the encrypted data packets may include broadcast or multicast user datagram protocol (UDP) packets. The UDP packets can be used in networks where interception of the communication by a Hypertext Transfer Protocol (HTTP) proxy can be avoided. For example, in the example of FIG. 4, where an application on the protected wireless network 110 transmits the encrypted data packets, the UDP packets can be used without being intercepted, since the communication is within the protected wireless network with no proxy involved.

The user of phone 150 (or laptop 140) can scan a device-unique QR code, or other indicia, printed on a housing of device 130 or included with the device 130 which directly or indirectly leads to downloading and running a software component or application 410 on the computing device 150. The QR code may include, for example as part of a uniform resource locator (URL), information that identifies device 130 or from which a public key or other encryption key may be derived for encrypting configuration information. The software component or application can prompt the user for the wireless network name and password or automatically detect the wireless network name and password from the computing device 150. The device 130 identified by the QR code can then be configured by the software component or application 410 transmitting encrypted packets to be overhead by the device 130 (440, 444 and 448 in FIG. 4).

FIGS. 5A-5C illustrates examples of packet encoding, according to various embodiments. Packet lengths may be constrained to a set of certain possible values due to padding added when the packet is encrypted by the wireless access point 120. The list of possible lengths of encrypted packets and the corresponding length of the payload that needs to be sent to achieve a length, can be easily determined or measured by someone skilled in the art. This exercise may need to be repeated for different common encryption schemes used by access points. FIG. 5A illustrates a sample packet structure. As illustrated in FIG. 5A, a packet 500 may include a packet type 501 (e.g., 802.11 standard), a TCP/IP header 503, a payload 505 and a padding 507 combined from a multiple of the encryption cypher size (typically 16 bytes). However, the breakdown of sizes of components 503 to 507 may not be known to the device 130 due to encryption. For example, if one or more bytes of padding 507 is present, increasing the length of the payload 505 by one byte may reduce the length of the padding 507 by one byte leaving the observable length the same. Similarly, if the total length of TCP/IP header 503 and the payload 505 is an exact multiple of 16, then no padding 507 can be present. In this situation increasing the payload 505 by one byte may result in 15 bytes of padding 507 being added to maintain the total length as a multiple of 16. This is observable as a different length (16 bytes longer).

Typically, most network traffic tends to be either minimum length, such as address resolution protocol (ARP) and TCP acknowledgement traffic, or maximum length, such as TCP transfer of bulk data. In the preferred embodiment of the disclosure, these lengths can be removed from the set of lengths used for conveying encoded configuration information data for configuring device 130.

Multiple packets can be used to convey a symbol, where each symbol represents a specific value of bit or bits. This approach can be used to help filter out packets not related to the process that just happen to be the right length. For example, using a 100-byte packet followed by a 200-byte packet to mean a “0” bit and a 300-byte packet followed by a 400-byte packet to mean a “1” can reduce the chance of miss-trigger due to an unrelated 100-byte or 200-byte packet. FIG. 5B illustrates an example of encoding data based on packet lengths. As illustrated in FIG. 5B, a sequence of packets 500 is sent in the order illustrated by arrow 511. Packets 500 can have various lengths 513. However, within the sequence illustrated in FIG. 5B an encrypted code “1000” can be conveyed where a “0” is encoded as a 100-byte packet followed by a 200-byte packet and a “1” is encoded as a 300-byte packet followed by a 400-byte packet.

In some cases, the symbols can be represented by ranges of packet lengths. For example, packets with lengths between 400 to 500 bytes can represent a “0” bit, while packets with lengths between 600 to 700 bytes can represent a “1” bit. To avoid false positives, more complex signaling schemes can be used. For example, particular sequences of packet lengths can be used to extract a portion of a configuration information such that, for example, a packet of length between 400 to 500 bytes followed by a packet of a length between 600 to 700 bytes may represent a “0” bit, while a packet of length between 700 to 800 bytes followed by a packet of a length 700 to 800 bytes can represent a “1” bit. In addition, a packet length may encode more than one bit. For example, packets with lengths between 400 to 500 bytes can represent two bits “00”, while packets with lengths between 600 to 700 bytes represent two bits “01”, packets with lengths between 800 to 900 bytes can represent two bits “10”, and packets with lengths between 1000 to 1100 bytes represent two bits “11”.

In another example, time-slices can be used where a time-slice can convey a symbol (one or more bits). Packet position encoding can be used to covey data similar to pulse-position-encoding where the time between pulses is used to indicate a bit or sequence of bits. A “pulse” may be a single packet or multiple packets. FIG. 5C illustrates an example of encoding data based on time slices or pulse-positon-encoding. As illustrated in FIG. 5C, a sequence of packets 500 is sent in the order illustrated by arrow 521. There can be different time-slice gaps between packets 500. However, within the sequence illustrated in FIG. 5C an encrypted code “001” can be conveyed where a time-slice 523 is encoded as a “0” while a time slice 525 is encoded as a “1”. In this example, a miss-trigger due to other traffic can corrupt the symbol/time-slice. However, the message may still be the same length and therefore inserted bad data can be avoided. This makes Forward Error Correction (FEC) significantly easier.

In addition, the encrypted data packets can be encoded based on a Forward Error Correction (FEC) technique to increase resilience to symbol errors. For example, the data packets can be encoded in a redundant way using an error correction code such that errors occurring in the data can be detected.

In some cases, a pseudo random number sequence known to devices participating in the wireless network 110 and to the server 170 can be used to change the encoding scheme of the data packets. For example, when the encoding is performed based on packet lengths as described with regards to FIG. 5B, the pseudo random number can change what data the length or sequence of lengths of packets 500 represent. For example, if packets with length 100 bytes represent a “0” bit, the pseudo random number can change the encoding such that packets with lengths between 300 bytes represent a “0” bit. This approach can be used to mitigate problems caused by other protocols operating within the wireless network 110 that may happen to send patterns of packets that would otherwise result in repeated miss-triggering of a specific symbol. For example, with this approach a 100 byte packet sometimes may represent a “0” bit and some other times may not represent any bit, depending on the pseudo random number for that time-slice. Therefore, an unrelated protocol that may sends multiple 100 byte packets may partially corrupt the encoded data within the packets but parts of the encoded data can be safely conveyed. The Forward Error Correction can then recover the reduced amount of corrupted data.

The wireless configuration information or configuration data required by a device 130 for participating in the wireless network 110 can be encrypted or scrambled with a different initialization vector (IV) used on each attempt. This can whiten the data such that it is different with each attempt thus reducing problems due to interference patterns. For example, data whitening can transforms the data having a known dispersion matrix into new data whose dispersion matrix is the identity matrix, meaning that data items are uncorrelated.

Multiple combinations of the described techniques such as, for example, time-slice periods, encryption-specific length mappings, pulse-positon-encoding, etc. can be used in sequence to work around interference issues.

The device 130 can observe various wireless channels by scanning through the wireless channels until it can successfully determine wireless network configuration information and its required configuration data. The sending system (e.g., server 170, laptop 140, phone 150, etc.) can repeatedly send the wireless network configuration information until the device 130 successfully joins the wireless network 110 and communicates success, or the process is aborted for whatever reason (e.g., user stops the process, timeout, etc.)

In another embodiment of the invention the user can use a web browser on laptop 140 or phone 150 and enters a device-unique URL printed on or included with the device 130 to bring up an internet website provided by server 170. The user can submit the name and password of protected wireless network 110. The device 130 identified by the URL can then then be automatically configured by the web server 170 by sending encrypted packets to the client device 140 or 150 intended to be overhead by the device 130.

In another embodiment of the invention the user can use a web browser on laptop 140 or phone 150 and enter a device-unique URL printed on or included with the device 130 which directly or indirectly leads to downloading and running a software component or application from server 170. The software component or application can prompt the user for the name and password of the protected wireless network 110 or automatically detects the protected wireless network's name and password from the computing device 140 or 150. The device 130 identified by the URL can then be automatically configured by the software component or application downloaded on laptop 140 or phone 150 by sending encrypted data packets to be overhead by the device 130.

In another embodiment of the invention the user can access a website using a web browser on laptop 140 or phone 150, for example by using a QR code, a printed URL, an automatic launch as part of an installer, etc. The user can submit the identification number of the device 130 to be added to the protected wireless network, and submit the name and password of the protected wireless network 110. The device 130 can then be automatically configured by the web server 170 by sending encrypted data packets to the laptop 140 or phone 150 intended to be overhead by the device 130.

In another embodiment of the invention the user can run a software component or application where the software component or application prompts the user to identify the device 130), name of the protected wireless network 110, and password of the protected wireless network 110. The device 130 can then be automatically configured by the software component or application sending encrypted data packets to be overhead by the device 130.

In another embodiment of the invention the user can run a software component or application on laptop 140 or phone 150 where the password of the protected wireless network 110 is automatically detected from the computing device 140 or 150 running the installer or application.

The webpage provided by server 170 illustrated in FIG. 2, or the application running on a computing device 150 illustrated in FIG. 4 may display on a display unit of the computing device 140 or 150 a picture of the device 130 to the user. The make/model of device 130 can be determined by the device identification number obtained from the QR code Unified Resource Locator (URL), from the user entered identification number of device 130, from a model-specific URL, from user selection of the model, or from other means.

In some cases, in order to prevent network security information from being transferred to an external server 170 or being overheard by an unwanted third party, the wireless network configuration information (e.g., the configuration data) can be encrypted by a computing device 140 or 150. This can be achieved by the computing device 140 or 150 retrieving the public key of device 130 from the external server 170, from the QR code, from a printed code on or supplied with the device 130, etc.

The webpage provided by server 170 illustrated in FIG. 2, or the application running on a computing device 150 illustrated in FIG. 4 may show successful retrieval of configuration data by device 130 based on the device 130 successfully joining the wireless network 110. For the website based approach of FIG. 2, this can be detected by the device 130 “phoning home” to the website 220 via the wireless network 110 and associated internet connection 160. For the application based approach of FIG. 4, this can be detected by a similar approach, or by local network communication within network 110.

The features of the disclosure may be applied to reconfiguring a device 130. For example, if the user changes the name or password of the wireless network 110, the discussed features can be applied to change the configuration of the device 130 to use the new name and/or password. This detailed description is intended to be illustrative only, and should not be taken as limiting the scope of the invention. To illustrate, while the description describes 802.11 wireless networks, embodiments are not so limited. For example, non-802.11 wireless networks or non-wireless networks that are protected and have a need to be able to add devices can use the described features. Therefore, the specification and drawings are to be regarded in an illustrative rather than a restrictive sense.

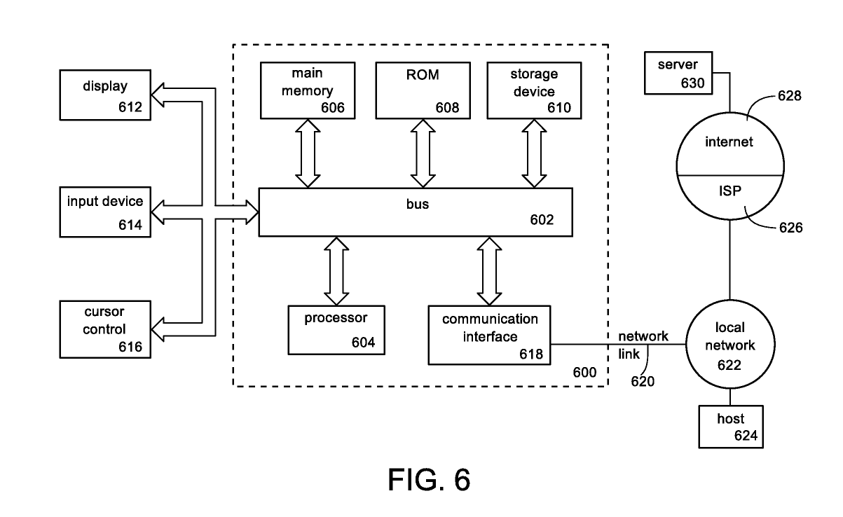

FIG. 6 is a block diagram that illustrates a computer system 600 upon which aspects of this disclosure may be implemented, such as, but not limited to laptop 140, phone 150 and server 170. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT) or liquid crystal display (LCD), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Another type of user input device is a touchscreen, which generally combines display 612 with hardware that registers touches upon display 612.

This disclosure is related to the use of computer systems such as computer system 600 for implementing the techniques described herein. In some examples, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In some examples, hard-wired circuitry may be used in place of or in combination with software instructions to implement the various aspects of this disclosure. Thus, implementations are not limited to any specific combination of hardware circuitry and software.

The term “machine-readable medium” as used herein refers to any medium that participates in providing data that causes a machine to operation in a specific fashion. In some examples implemented using computer system 600, various machine-readable media are involved, for example, in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

In view of the wide variety of permutations to the embodiments described herein, this detailed description is intended to be illustrative only, and should not be taken as limiting the scope of the invention. To illustrate, while the description describes transport stream based digital television broadcasts being received by tuner based devices, embodiments are not so limited. For example, cable television, satellite television, other sources of broadcast or multicast video, audio, or non-audio/video content, non-transport-stream based content, etc. Therefore, the specification and drawings are to be regarded in an illustrative rather than a restrictive sense.

The separation of various system components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 105 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. An apparatus comprising a processor configured to cause the apparatus to perform operations comprising:
detecting a protected wireless network;
observing a plurality of encrypted wireless data packets being transmitted by one or more devices participating in the protected wireless network, wherein configuration information for participating in the protected wireless network has been encoded according to a predefined protocol in sizes or times of transmission of the plurality of encrypted wireless data packets;
determining the configuration information based on sizes or times of receipt of a portion of each of the plurality of encrypted wireless data packets; and
participating in the protected wireless network using the determined configuration information.

2. The apparatus of claim 1, wherein the operations further comprise:
generating a first bitstream based on sizes or times of receipt of portions of each of the plurality of encrypted wireless data packets;
generating a second bitstream by applying Forward Error Correction (FEC) processing to the first bitstream; and
determining the configuration information based on the second bitstream.

3. The apparatus of claim 1, wherein the operations further comprise:
generating a first bitstream based on sizes or times of receipt of portions of each of the plurality of encrypted wireless data packets;
generating a second bitstream by decrypting the first bitstream using a decryption key; and
determining the configuration information based on the second bitstream.

4. The apparatus of claim 3, wherein the operations further comprise:
obtaining the decryption key based on data stored in the apparatus; and
decrypting the second bitstream using the decryption key as a private key for a public-key cryptographic algorithm.

5. The apparatus of claim 4, further comprising a housing bearing an indicia corresponding to a public key effective for encoding data for decryption using the decryption key.

6. The apparatus of claim 1, wherein the operations further comprise providing an indication that the apparatus successfully determined the configuration information to a device participating in the protected wireless network or to a server outside of the protected wireless network.

7. A method for providing configuration information for a protected wireless network to a first device to allow the first device to participate in the protected wireless network, the method comprising:
establishing one or more network connections each initiated by a second device via the protected wireless network;
obtaining the configuration information in an unencoded, encoded, or encrypted form;
determining first sizes or times of transmission for a first plurality of data packets, wherein the first sizes or times of transmission encode the obtained configuration information according to a first predefined protocol; and
generating and transmitting, to the second device via the one or more established network connections, the first plurality of data packets according to the determined first sizes or times of transmission.

8. The method of claim 7, further comprising:
receiving a notification from the second device indicating that the second device was unable to determine the configuration key based on data packets received by the second device in response to the transmitting of the plurality of data packets;
determining, in response to receiving the notification, second sizes or times of transmission for a second plurality of data packets, wherein the second sizes or times of transmission encode the configuration information according to a second predefined protocol, wherein the second protocol is different from the first protocol; and
generating and transmitting, to the second device via the one or more established network connections, the second plurality of data packets according to the determined second sizes or times of transmission.

9. The method of claim 7, further comprising:
generating a first bitstream based on the configuration information;
generating a second bitstream by Forward Error Correction (FEC) processing of the first bitstream; and
determining the first sizes or times of transmission based on the second bitstream.

10. The method of claim 7, further comprising:
obtaining an encryption key for the first device;
generating a first bitstream based on the configuration information;
generating a second bitstream by encrypting the first bitstream using the encryption key; and
determining the first sizes or times of transmission based on the second bitstream.

11. The method of claim 7, wherein the one or more network connections include one or more TCP/IP based connections.

12. The method of claim 7, wherein the one or more TCP/IP based connections include one or more HTTP connections initiated by the second device.

13. A method for providing configuration information for a protected wireless network to a first device to allow the first device to participate in the protected wireless network, the method comprising:
requesting, via the protected wireless network, a webpage from a server;
receiving the webpage, wherein the webpage includes first instructions which, when executed by a second device participating in the protected wireless network, cause the second device to transmit a first plurality of encrypted data packets via the protected wireless network;
obtaining the configuration information for the protected wireless network;
executing the first instructions to transmit, via the protected wireless network, the first plurality of encrypted data packets, wherein the first plurality of encrypted data packets have first sizes or times of transmission that encode the configuration information according to a first predefined protocol.

14. The method of claim 13, further comprising:
determining that the first device did not begin participating in the protected wireless network;
receiving second instructions which, when executed by the second device, cause the second device to transmit a second plurality of encrypted data packets via the protected wireless network;
executing the second instructions to transmit, via the protected wireless network, the second plurality of encrypted data packets, wherein the second plurality of encrypted data packets have second sizes or times of transmission that encode the configuration information according to a second predefined protocol, wherein the second protocol is different from the first protocol.

15. The method of claim 13, wherein the first plurality of encrypted data packets encode the configuration information based on a Forward Error Correction (FEC) processing technique.

16. The method of claim 13, further comprising:
obtaining the configuration information via a user interface provided by the second device; and
executing the first instructions to determine the first sizes or times of transmission based on the obtained configuration information.

17. A method for providing configuration information for a protected wireless network to a first device to allow the first device to participate in the protected wireless network, the method comprising:
obtaining the configuration information for the protected wireless network;
determining sizes or times of transmission for a plurality of encrypted data packets, wherein the sizes or times of transmission encode the configuration information according to a predefined protocol; and
transmitting the plurality of encrypted data packets via the protected wireless network.

18. The method of claim 17, wherein the plurality of encrypted data packets encode the configuration information based on a Forward Error Correction (FEC) processing technique.

19. The method of claim 17, wherein the plurality of encrypted data packets include UDP packets

20. The method of claim 17, wherein the plurality of encrypted data packets include broadcast or multicast packets.
